(19) United States
(12) Patent Application Publication
(10) Pub. No.: US 2002/0074683 A1
(43) Pub. Date: Jun. 20, 2002

(54) Process for producing polycarbonate and products therefrom

(76) Inventors: Christoph Schwemler, League City, TX (US); Thomas Elsner, Dusseldorf (DE); Jurgen Heuser, Krefeld (DE); Christian Kords, Krefeld (DE)

Correspondence Address: BAYER CORPORATION, PATENT DEPARTMENT, 100 BAYER ROAD, PITTSBURGH, PA, 15205, US

(21) Appl. No.: 09/933,360

(22) Filed: Aug. 20, 2001

(30) Foreign Application Priority Data
Aug. 23, 2000 (DE) 10052873.2

(51) Int. Cl. B29C 45/00; B29C 47/76

(52) U.S. Cl. 264/102; 264/176.1; 264/328.17

(57) ABSTRACT

A process for making a shaped product from thermoplastic polycarbonate is disclosed. The process comprises producing polycarbonate melt by a method selected from the group consisting of phase interface and melt transesterification and introducing the melt directly into a forming apparatus to form a shaped product. The forming apparatus is selected from the group consisting of an injection molding machine and an extruder. The process is characterized in the absence therefrom of polycarbonate in granular form.

This invention relates to an improved process for making products from polycarbonate and to the actual products thus produced.

In order to produce polycarbonates by the so-called phase interface process, dihydroxydiarylalkanes in the form of their alkali metal salts are reacted with phosgene in heterogeneous phase in the presence of inorganic bases, such as sodium hydroxide solution, and of an organic solvent in which the polycarbonate product is readily soluble. During the reaction, the aqueous phase is distributed in the organic phase and after the reaction the organic, polycarbonate-containing phase is washed with an aqueous liquid, which is intended to remove inter alia electrolytes, and the washing liquid is then separated off.

During the further processing, the solvent is removed and finally the polycarbonate in granular form is made available for subsequent further processing into products such as, for example, magneto-optical articles, in particular laser-readable data storage, lenses of headlights for the automotive industry, optical lenses, polycarbonate sheets, films et cetera. In order to make these products, the granular material has to be melted again and the melt further processed, for example, by the injection moulding or extrusion technique, depending on the required product.

Likewise, polycarbonate which has been produced by the melt transesterification process, in which bisphenols are reacted with diaryl carbonates in the melt with the release of hydroxyaryls, is first of all processed to form granules, which then have to be melted again for further processing, for example, by the injection moulding or extrusion process.

The object of the invention is to achieve improvements in the quality of polycarbonate products by means of an improved production process. Surprisingly, object is achieved by introducing the polycarbonate melt directly into the production, without previous granulation; prior to this processing, of course, other conventional purification steps such as, for example, filtrations can still be interposed. The decreased thermal stress on the material results in an improvement in the quality of the products. In addition, the elimination of an additional processing step also achieves the object of providing a simpler and correspondingly more efficient process for producing polycarbonate products.

The invention provides firstly a process for making polycarbonate products wherein a polycarbonate solution obtained by the phase interface process is washed with an aqueous washing liquid, the washing liquid is separated off and the solvent evaporated off, and wherein the mixture of organic polycarbonate solution and residual washing liquid which is obtained after the removal of the washing liquid is heated by indirect heat exchange in order to attain a clear solution and is filtered in order to separate off solid substances, and then

A) in a first stage, in one or more individual steps the solution, which has a polymer content of 5 to 20 wt. % is concentrated to 60 to 75 wt. % at a temperature of 150° C. to 250° C. in a combination of a shell-and-tube heat exchanger and a film evaporator or a coiled-tube evaporator, or in a shell-and-tube heat exchanger, in each case with downstream separator, the pressure in the separator being about 0.1 to 0.4 MPa, preferably ambient pressure (i.e. about 0.1 MPa),

B) in a further step, the solution is concentrated from 60 to 75 wt. % to at least 95 wt. %, in particular to 98 to 99.9 wt. %, at a temperature of 250° C. to 350° C., in a shell-and-tube heat exchanger with downstream separator, the shell-and-tube heat exchanger containing vertical, heated, straight tubes with or without incorporated static mixers, having an internal diameter of 5 to 30 mm, preferably of 5 to 15 mm, a length of 0.5 to 4 m, preferably of 1 to 2 m, and the throughput per heat-exchanger tube through the tubes being 0.5 to 10 kg/h, preferably 3 to 7 kg/h, based on the polymer, and the pressure in the separator being 0.5 kPa to 0.1 MPa, in particular 3 kPa to 0.1 kPa, preferably 3 kPa to 10 kPa,

C) in a third step, the solution containing the remains of solvent and/or other volatile components are removed until the content of solvent and/or of other volatile components is 5 to 500, at a temperature of 250° C. to 350° C., in particular at 260° C. to 320° C., most particularly preferably at 270° C. to 310° C. and ideally at 280° C. to 290° C., in a further shell-and-tube heat exchanger or in an extruder-evaporator, the shell-and-tube heat exchanger containing vertical, heated, straight tubes having an internal diameter of 5 to 30 mm, preferably of 10 to 20 mm, a length of 0.2 to 2 m, preferably of 0.5 to 1 m, and the throughput per heat-exchanger tube through the tubes being 0.5 to 10 kg/h, preferably 3 to 7 kg/h, based on the polymer, and the pressure in the separator being 0.05 kPa to 0.1 MPa, preferably 0.1 kPa to 2 kPa,

and the melt is used directly for making the polycarbonate products.

In the direct use of the melt, the temperatures given under C. are advantageous because these are definitely lower than the temperatures occurring during the final evaporation by means of extruder which is conventionally used in this step; the result is a lower thermal stress on the product and thereby also a product of higher quality. The elimination of the otherwise conventional remelting of the granular material leads to simplification as well as to a lower thermal stress on the product and thereby to an improvement in the quality of the product.

Alternatively, the polycarbonate melts obtained from the conventional evaporation process, for example, using an extruder-evaporator, can also be further processed directly, optionally cooled to a suitable temperature. In the same manner, polycarbonate melts obtained from the melt transesterification process can also be further processed directly, optionally cooled to a suitable temperature.

Whereas the evaporator systems used under A and B correspond to commercially available devices, in step C the temperatures adhered to there necessitate the use of special evaporating devices. Depending on the product into which the melts are to be processed, the use of an evaporator is also sufficient, for example, for the production of polycarbonate sheets. Tubular evaporators and extruder-evaporators suitable for this purpose are given as examples, which are not intended to be limiting, in the previously unpublished German Patent Application No. 19957458.8.

According to the invention, the term “polycarbonate” is to include both homopolycarbonates and copolycarbonates and mixtures thereof. The polycarbonates according to the invention may be aromatic polyester carbonates or polycarbonates in a mixture with aromatic polyester carbonates. The term “polycarbonate” will be used subsequently in place of the previously mentioned polymers.

The polycarbonate according to the invention is obtained by the so-called phase interface process (H. Schnell, “Chemistry and Physics of Polycarbonates”, Polymer Review, Vol. IXS, 22 ff., Interscience Publishers, New York 1964), in which the polycarbonate-containing solution is subsequently washed with a washing liquid, the washing liquid is separated off and the solution is evaporated off.

Alternatively, the polycarbonate can also be obtained by the so-called melt transesterification process (D. G. LeGrand et al., “Handbook of Polycarbonate Science and Technology”, Marcel Dekker Verlag, New York, Basel, 2000, p. 12 ff.).

The melts obtained at the end of the respective production process are not subsequently granulated, but are further processed directly into the end products.

Compounds preferably used as starting compounds according to the invention are bisphenols corresponding to the general formula HO—Z—OH, wherein Z is a divalent organic group having 6 to 30 carbon atoms which contains one or more aromatic groups. Examples of such compounds are bisphenols, which belong to the group comprising dihydroxydiphenyls, bis(dihydroxyphenyl)alkanes, indane bisphenols, bis(hydroxyphenyl)ethers, bis(hydroxyphenyl)sulfones, bis(hydroxyphenyl)ketones and α,α′-bis(hydroxyphenyl)diisopropylbenzenes.

Particularly preferred bisphenols, which belong to the above-mentioned groups of compounds, are 2,2-bis(4-hydroxyphenyl)propane (bisphenol A), tetraalkylbisphenol A, 4,4-(meta-phenylenediisopropyl)diphenol (bisphenol M), 1,1-bis(4-hydroxyphenyl)-3,3,5-trimethylcyclohexanone as well as optionally mixtures thereof. Particularly preferred copolycarbonates are those based on the monomers bisphenol A and 1,1-bis(4-hydroxyphenyl)-3,3,5-trimethylcyclohexane. The bisphenol compounds to be used according to the invention are reacted with compounds of carbonic acid, in particular phosgene and diphenyl carbonate.

The polyester carbonates according to the invention are obtained by reaction of the phenols already mentioned above, at least one aromatic dicarboxylic acid and optionally carbonic acid. Suitable aromatic dicarboxylic acids are, for example, orthophthalic acid, terephthalic acid, isophthalic acid, 3,3'- or 4,4'-diphenyldicarboxylic acid and benzophenonedicarboxylic acids.

Inert organic solvents used in the process are preferably dichloromethane or mixtures of dichloromethane and chlorobenzene.

The reaction can be accelerated by catalysts, such as tertiary amines, N-alkylpiperidines or onium salts. Preferably tributylamine, triethylamine and N-ethylpiperidine are used. A monofunctional phenol, such as phenol, cumylphenol, p-tert. butylphenol or 4-(1,1,3,3-tetramethylbutyl)phenol can be used as a chain stopper and molar mass controller. Isatinbiscresol, for example, can be used as a branching agent.

To produce high-purity polycarbonates according to the invention by the phase interface process, the bisphenols are dissolved in aqueous alkaline phase, preferably sodium hydroxide solution. The chain stoppers optionally required for the production of copolycarbonates are dissolved in quantities of 1.0 to 20.0 mol. % per mol bisphenol in the aqueous alkaline phase or added to the latter in solid form in an inert organic phase. Then phosgene is introduced into the mixer containing the other reaction components and the polymerisation is carried out.

A part, up to 80 mol. %, preferably from 20 to 50 mol. %, of the carbonate groups in the polycarbonates can be replaced by aromatic dicarboxylic ester groups.

In a further development of the invention, the thermoplastic polycarbonates have average molecular weights M_{W} and a foreign particle index of less than 2.5·10⁴ μm/g. The sodium content is preferably less than 30 ppb, measured by atomic absorption spectroscopy.

During the reaction, the aqueous phase is emulsified in the organic phase. In the course of this, droplets of differing size are formed. After the reaction, the organic phase containing the polycarbonate is generally washed several times with an aqueous liquid and after each washing process is as far as possible separated from the aqueous phase. Dilute mineral acids such as HCl or H₃PO₄ are used as washing liquid for the separation of the catalyst and demineralised water is used for the further purification. The concentration of HCl or H₃PO₄ in the washing liquid can be, for example, 0.5 to 1.0 wt. %.

The in principle known separatory vessels, phase separators, centrifuges or coalescers, or combinations of these items of equipment, can be used as phase-separating devices for the removal of the washing liquid from the organic phase.

The solvent in steps A to C described above is evaporated off in order to obtain the high-purity polycarbonate.

Besides the solution polycarbonate process described, the melt transesterification process can also be used in order to produce the polycarbonate melt.

In the melt transesterification process, polycarbonate is produced, for example, in a 2-step process, starting from aromatic diphenols, diaryl carbonates and catalysts at temperatures of between 80° C. and 320° C. and at pressures of 1000 mbar to 0.01 mbar, in a way such that in the first step, involving the synthesis of oligocarbonate, quaternary ammonium compounds and/or phosphonium compounds are introduced in quantities of 10⁻⁴ to 10⁻⁸ mol, based on 1 mol bisphenol, with the melting of the reactants in the first step taking place at temperatures of 80° C. to 180° C., preferably at 100° C. to 150° C. , at atmospheric pressure over a period of up to 5 hours, preferably from 0.25 to 3 hours and, after addition of the catalyst and application of a vacuum (1 bar to 0.5 mbar) and elevation of the temperature (to 290° C.), an oligocarbonate is obtained by distilling off monophenols. In the second step, with the addition of alkali metal salts and alkaline-earth metal salts in quantities of between 10⁻⁴ to 10⁻⁸ mol, based on 1 mol bisphenol, at temperatures of between 240° C. and 320° C., preferably of 260° C. to 300° C., and at pressures of <500 mbar to 0.01 mbar this oligocarbonate is polycondensed within short periods of time (<3 hours) to form polycarbonate.

As may be gathered from the preceding description, the melt transesterification process is carried out without solvent. Unlike the solvent polycarbonate process, no evaporator/extruder-evaporator or extruder is therefore necessary here.

The polycarbonate melts thus obtained by the different processes are then further processed into the required products directly, without an intermediate step such as, for example, granulation and remelting; prior to this processing, of course, other conventional purification steps such as, for example, filtrations can still be interposed.

These products can be made, for example, by the injection moulding, extrusion or casting (film) processes. Examples of these products, which are not intended to be limiting, include polycarbonate sheets of the type for glazing greenhouses with twinwall sheets or double-walled sheets, solid sheets, magneto-optical data storage/mini disks, compact disks, DVD, optical lenses and prisms, optical fibres, glazing for motor vehicles, headlamps, films, medical equipment, packaging (for example, for food and medical products, et cetera), housings for electrical and electronic articles (for example, computer housings, parts of mobile phones, et cetera), spectacle lenses and frames, household objects (such as electrical articles, for example, irons, et cetera), toys, et cetera.

The process according to the invention is particularly suitable for making products which have to meet high standards as regards optical quality, i.e. transparency and colourlessness; for example, glazing for greenhouses and motor vehicles, headlamps, magneto-optical data storage/mini disks, compact disks, DVD, optical lenses and prisms, optical fibres, spectacle lenses, et cetera.

The process according to the invention is most particularly suitable for the production of glazing for greenhouses and motor vehicles and headlamps.

Another most particularly suitable application is the production of magneto-optical data storage/mini disks, compact disks and DVDs.

A further most particularly suitable application is the production of optical lenses and prisms, optical fibres and spectacle lenses.

The preferred molecular weight range for the data carrier is 12,000 to 22,000; for lenses and glazing, 22,000 to 32,000 and that for solid plates and double-walled sheets is 28,000 to 40,000. All data on molecular weights refer to the weight average of the molar mass.

What is claimed is:

1. A process for making a shaped product from thermoplastic polycarbonate comprising producing polycarbonate melt by a method selected from the group consisting of phase interface and melt transesterification and introducing the melt directly into a forming apparatus selected from the group consisting of an injection molding machine and an extruder, to form said shaped product, said process characterized in the absence therefrom of polycarbonate in granular form.

2. The process of claim 1 characterized in that the polycarbonate melt is degassed.

3. The process of claim 2 wherein melt is degassed by one or more tubular evaporators or extruder-evaporators.

4. The shaped product made by the process according to claim 1.

5. In the process of forming a shaped product of a thermoplastic aromatic polycarbonate from melt obtained by a method selected from the group consisting of phase interface and melt transesterification, the improvement comprising avoiding granulating the polycarbonate before introducing the melt directly into a forming apparatus selected from the group consisting of an injection molding machine and an extruder to form said shaped product.
